(19) United States
(12) Patent Application Publication
(10) Pub. No.: US 2023/0060892 A1
(43) Pub. Date: Mar. 2, 2023

(54) COLORFUL DAZZLING ARTIFACT

(71) Applicant: CHIN-SHENG YANG, Tainan City (TW)

(72) Inventor: CHIN-SHENG YANG, Tainan City (TW)

(21) Appl. No.: 17/458,596

(22) Filed: Aug. 27, 2021

(51) Int. Cl. B44F 1/06

(52) U.S. Cl. CPC B44F 1/06

(57) ABSTRACT

A colorful dazzling artifact includes supporting base, the supporting base being formed with a first opening and having an interior in which at least one light-emitting component and more than one light-transmitting vision window are arranged; a water-lamp main body, the water-lamp main body being arranged in the first opening of the supporting base, the water-lamp main body being of a hollow light-transmitting three-dimensional shape, in which a thick flowable liquid is received and hermetically enclosed; and at least one pattern decoration layer, the pattern decoration layer being fit inside the supporting base and corresponding to the light-transmitting vision window. Further, an ornamentation object and glitter powder may be arranged in the water-lamp main body. A rotating mechanism is provided to drive the ornamentation object to rotate and also to drive a liquid to flow so as to bring the glitter powder to flow therewith.

### TECHNICAL FIELD OF THE INVENTION

The present invention relates to the field of artifacts, and more particularly to a colorful dazzling artifact.

### DESCRIPTION OF THE PRIOR ART

In daily living, artifact decorations are commonly placed indoors on a desktop or a cabinet. Such decorations are generally photo frames, toys, and handcrafts. Such decorations provide only a static function for seeing and enjoying. Therefore, a water lamp, which is filled with sequins, glitter powder, or ornaments, is available in the market and is playful by inverting or shaking to cause sequins, glitter powder, or ornaments to generate liquid movement inside the lamp for being visually perceived.

However, diversification of such a kind of artifact decorations is limited to variation in respect of design and modification of the water lamp itself. Thus, the development of such a kind of artifact decorations is constrained. The present applicant has been long engaged in the manufacturing of such a kind of decoration and has been recently issued with U.S. Pat. No. 6,960,937 B2, which provides diversified visual variability for such a kind of decorations, as well as easiness of fabrication. Thus, such a kind of artifact decorations could be more eye-attracting to the general public if the playfulness or visual perception of the outside appearance of such a kind of artifact decorations can be upgraded through combination with various sorts of lighting effect.

### SUMMARY OF THE INVENTION

The primary objective of the present invention is to provide a colorful dazzling artifact that is excellent in respect of playfulness and visual effect.

To resolve the technical issue brought up above, the present invention provide the following technical solution:

A colorful dazzling artifact comprises a supporting base, the supporting base being formed with a first opening and having an interior in which at least one light-emitting component and more than one light-transmitting vision window are arranged; a water-lamp main body, the water-lamp main body being arranged in the first opening of the supporting base, the water-lamp main body being of a hollow light-transmitting three-dimensional shape, in which a thick flowable liquid is received and hermetically enclosed; and at least one pattern decoration layer, the pattern decoration layer being fit inside the supporting base and corresponding to the light-transmitting vision window.

In one embodiment, the pattern decoration layer comprises a light-transmitting laser film that includes a custom-made pattern.

In one embodiment, the supporting base comprises a bottom seat.

In one embodiment, the supporting base comprises a bottom seat and further comprises sidewalls, the first opening being arranged in the bottom seat.

In one embodiment, the supporting base comprises a bottom seat and further comprises sidewalls and a top cover, the first opening being arranged in the bottom seat, the top cover being provided with a second opening and arranged to cover a top of the water-lamp main body.

In one embodiment, the supporting base is made of a light-transmitting material.

In one embodiment, the colorful dazzling artifact further comprises a rotating mechanism, the rotating mechanism comprising a driving rotation assembly and a driven rotation assembly, the driving rotation assembly being arranged in the supporting base, the driven rotation assembly being arranged at a bottom inside the water-lamp main body and being drivable by the driving rotation assembly to rotate.

In one embodiment, the water-lamp main body further comprises an ornamentation object and glitter powder arranged therein, the ornamentation object being mounted to the driven rotation assembly and being drivable to rotate by the driven rotation assembly, the glitter powder being disposed in the flowable liquid.

The efficacy of the present invention is that the colorful dazzling artifact comprises a supporting base, which may include a bottom seat, or may alternatively include the bottom seat and sidewalls, or may further alternatively include the bottom seat, the sidewalls and a top cover; a light-emitting component and a light-transmitting vision window is arranged in the supporting base, and also, a light-transmitting laser film that includes a custom-made pattern is fit inside the supporting base, such that the light-emitting component emits light and the light-transmitting laser film allows the light to project therethrough to thereby project colorful dazzling lighting through the light-transmitting vision window to the outside to thereby enhance the playfulness and overall visual effect of the artifact; and further, an ornamentation object and glitter powder are arranged in the water-lamp main body and a rotating mechanism may drive the ornamentation object to rotate and also to cause the glitter powder to flow with a liquid to thereby also enhance the overall playfulness and visual enjoyment of the artifact.

### BRIEF DESCRIPTION OF THE DRAWINGS

FIG. 1 is a perspective view showing a colorful dazzling artifact according to a first embodiment of the present invention.

FIG. 2 is a cross-sectional view showing the colorful dazzling artifact according to the first embodiment of the present invention.

FIG. 3 is a cross-sectional view showing a modified example of the colorful dazzling artifact according to the first embodiment of the present invention.

FIG. 4 is a perspective view showing a colorful dazzling artifact according to a second embodiment of the present invention.

FIG. 5 is a perspective view showing a modified example of the colorful dazzling artifact according to the second embodiment of the present invention.

FIG. 6 is a perspective view showing a colorful dazzling artifact according to a third embodiment of the present invention.

FIG. 7 is a perspective view showing a modified example of the colorful dazzling artifact according to the third embodiment of the present invention.

FIG. 8 is a perspective view showing a colorful dazzling artifact according to a fourth embodiment of the present invention.

### DETAILED DESCRIPTION OF THE PREFERRED EMBODIMENT

It is noted that when a component is described as being “fixed” to another component, it can be directly on said another component or there may be an intermediating component existing therebetween. When a component is described as being “connected” to another component, it can be directly connected to said another component, or a component intermediating therebetween may simultaneously exist. Oppositely, when a component is described as being “directly on” another component, there is not any intermediating component. The terms used herein, such as “vertically”, “horizontally”, “left”, “right”, and the likes are provided for the purpose of illustration only.

Unless explicitly defined, all the technical and scientific terminology used herein are of the same meaning as that commonly understood by skilled person of the technical field. The terminology involved in the disclosure of the present invention is provided for the purpose of illustrating and explaining embodiments of the present invention and is not intended to impose undue constraint to the present invention. The term “and/or” as used herein includes any and all the combinations of one or more items listed.

### Embodiment 1

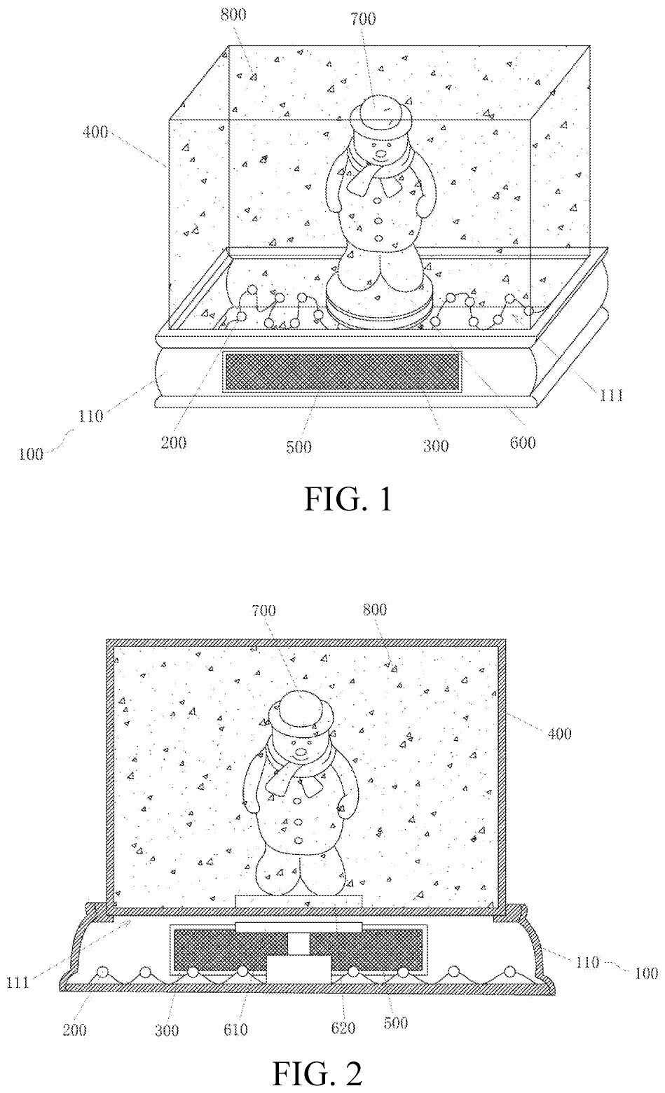

Referring to FIGS. 1-3, a colorful dazzling artifact comprises a supporting base 100, wherein the supporting base 100 is provided with a first opening 111 and has an interior in which at least one light-emitting component 200 and more than one light-transmitting vision window 300 are provided; a water-lamp main body 400, wherein the water-lamp main body 400 is arranged in the first opening 111 of the supporting base and the water-lamp main body 400 is of a hollow and light transmitting three-dimensional shape in which a thick flowable liquid is received hermetically; at least one pattern decoration layer 500, wherein the pattern decoration layer 500 is fit inside of the supporting base 100 and corresponds to the light-transmitting vision window 300.

Specifically, in the instant embodiment, the supporting base 100 comprises a bottom seat 110, and for the purposes of improving playfulness and visual effect of the artifact, the bottom seat 110 is opened with the first opening 111 facing upward, and the water-lamp main body 400 is arranged in the first opening 111, so that the water-lamp main body 400 and the bottom seat 110 are combined with each other, wherein the water-lamp main body 400 is of a three-dimensional shape, which can be rectangular or circular; and further, the bottom seat 110 receives the light-emitting component 200 and the light-transmitting vision window 300 to arranged in the interior thereof and the numbers of the light-emitting component 200 and the light-transmitting vision window 300 can be one or multiple, selected according to actual fabrication, and the light-emitting component 200 is in electrical connection with a circuit assembly arranged inside the bottom seat 110 to power the light-emitting component 200 to emit light; and further, the bottom seat 110 is further provided, in the inside thereof, with the pattern decoration layer 500, wherein the pattern decoration layer 500 is provided as a custom-made patterned light-transmitting laser film, and the patterned light-transmitting laser film is fit in the light-transmitting vision window 300, so that light emitting from the light-emitting component 200 can transmit through the light-transmitting laser film to then pass through the light-transmitting vision window 300 of the bottom seat 110 for outward projection to allow the bottom seat 110 to emit colorful dazzling light, and further, the light may pass through the first opening 111 to project upward so as to make light projecting out of the water-lamp main body 400 also, wherein the light projecting through the water-lamp main body 400 is subject to refraction by a flowing liquid contained in the interior thereof to also make colorful and dazzling light, and consequently, the playfulness and overall visual effect of the artifact can be enhanced.

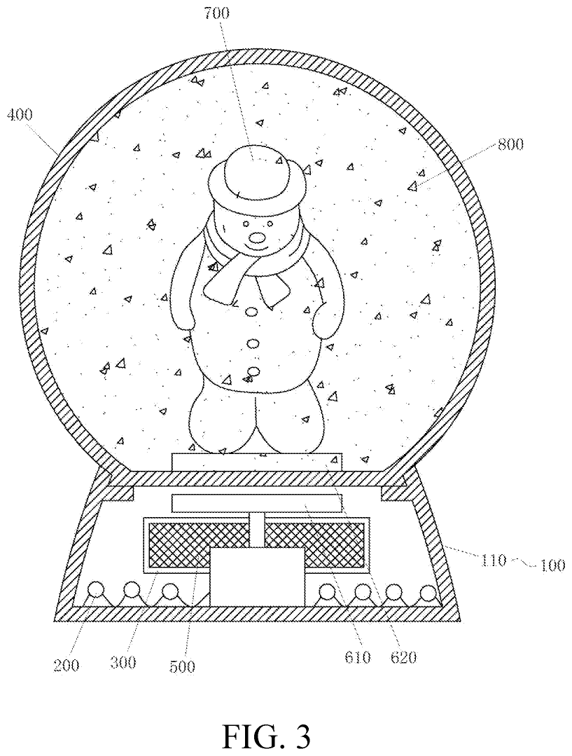

Referring to FIG. 2 or 3, the colorful dazzling artifact further comprises a rotating mechanism 600. The rotating mechanism 600 comprises a driving rotation assembly 610 and a driven rotation assembly 620. The driving rotation assembly 610 is arranged inside the supporting base 100, while the driven rotation assembly 620 is disposed at a bottom inside the water-lamp main body 400 and is drivable by the driving rotation assembly 610 to rotate.

Further, provided inside the water-lamp main body 400 includes an ornamentation object 700 and a glitter powder 800. The ornamentation object 700 is mounted on the driven rotation assembly 620, and is driven by the driven rotation assembly 620 to rotate. The glitter powder 800 is provided in the flowable liquid.

In the instant embodiment, in order to achieve good visual effect and playfulness for the artifact, the colorful dazzling artifact is structured to further include the rotating mechanism 600, wherein the rotating mechanism 600 comprises the driving rotation assembly 610 and the driven rotation assembly 620; and the driving rotation assembly 610 is arranged inside the bottom seat 110 and the driving rotation assembly 610 is made up of a rotating electric machine and a magnetic member, such that the rotating electric machine may drive the magnetic member to rotate; and the driven rotation assembly 620 is arranged inside the water-lamp main body 400 and the driven rotation assembly 620 is also made up of a magnetic member so that when the rotating electric machine drives the magnetic member of the driving rotation assembly 610 to rotate, the magnetic member of the driven rotation assembly 620 is caused to rotate through mutual magnetic expulsion;

and further, due to the water-lamp main body 400 being structured to include the ornamentation object 700 and the glitter powder 800 therein, and the ornamentation object 700 being mounted to the driven rotation assembly 620, when the driven rotation assembly 620 is set in rotation, the ornamentation object 700 is caused to rotate and also, when the driven rotation assembly 620 drives the ornamentation object 700 to rotate, the thick flowable liquid contained in the water-lamp main body 400 is forced to flow, and the glitter powder 800 contained in the liquid moves with the flow, and consequently, the playfulness and overall visual effect of the artifact are enhanced.

### Embodiment 2

An artifact according to the instant embodiment is generally similar to that of the first embodiment with a primary difference being that the supporting base 100 comprises a bottom seat 110 and sidewalls 120.

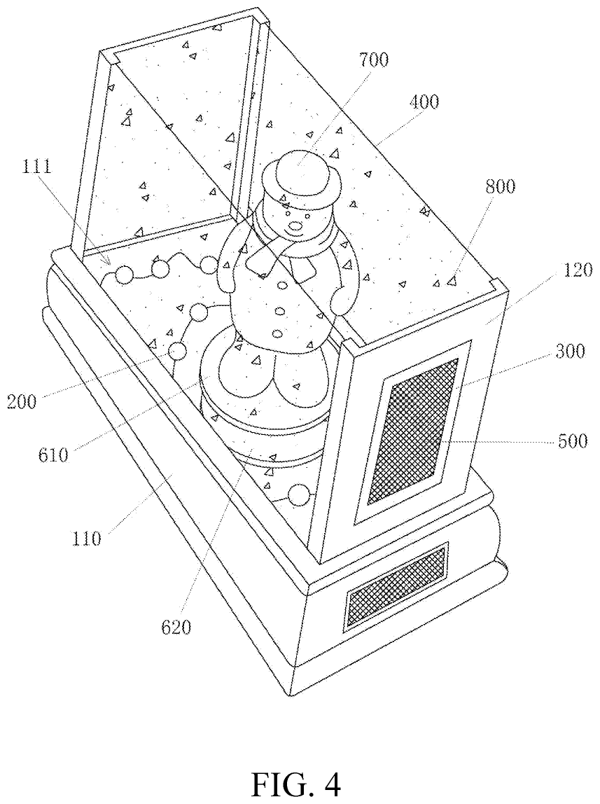

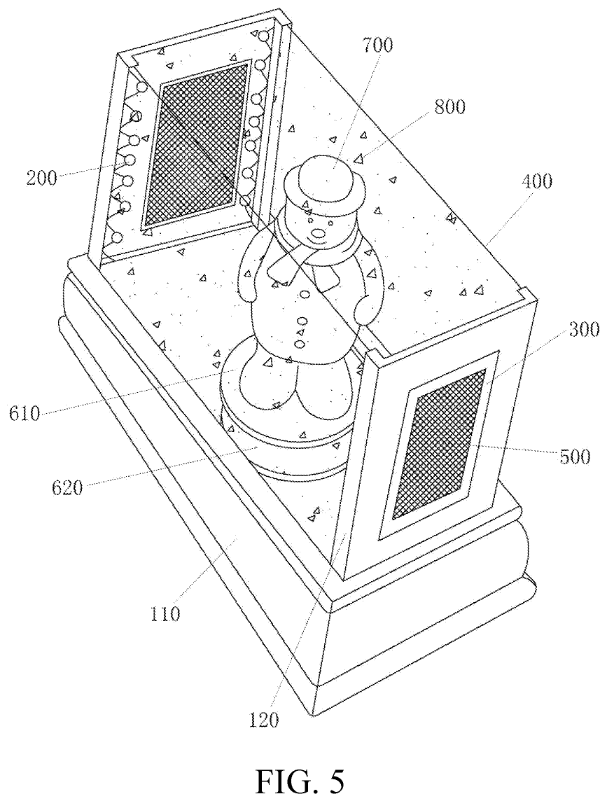

Specifically, Referring to FIGS. 4 and 5, for the case that the supporting base 100 comprises the bottom seat 110 and the sidewalls 120, the first opening 111 is similarly formed in the bottom seat 110, and similarly, one or multiple light-emitting components 200 and light-transmitting vision windows 300 can be arranged in the bottom seat 110, and possibly, the light-emitting component 200 and the light-transmitting vision window 300 can be arranged on the sidewalls 120, and also possibly, the light-transmitting vision window 300 and the light-emitting component 200 can be arranged in the bottom seat 110 and also on the sidewalls 120, and the patterned light-transmitting laser film of the pattern decoration layer 500 is fit in the light-transmitting vision window 300.

In case that the sidewalls 120 are provided with the light-emitting component 200 and the light-transmitting vision window 300, the light-emitting component 200 can be attached, by means of adhesive, to an inner surface of the sidewalls 120, and set in electrical connection with the circuit assembly inside the bottom seat 110, such that light emitting from the light-emitting component 200 pass through the light-transmitting vision window 300 provided on the sidewalls 120 and the light-transmitting laser film fit therein to project out colorful dazzling lighting, and also, the light also directly irradiates the water-lamp main body 400 to similarly project out colorful dazzling lighting, and consequently, the playfulness and overall visual effect of the artifact are enhanced.

Further, in the case that the light-emitting component 200 and the light-transmitting vision window 300 are respectively provided in the sidewalls 120 and the bottom seat 100, light emitting from the light-emitting component 200 provided on the sidewalls 120 irradiates the water-lamp main body 400, such that the water-lamp main body 400 projects the light through the first opening 111 into the bottom seat 110, and eventually, the light-transmitting vision window 300 on the bottom seat 110 projects out colorful dazzling lighting by means of the light-transmitting laser film, and similarly, the playfulness and overall visual effect of the artifact are enhanced.

### Embodiment 3

An artifact according to the instant embodiment is generally similar to that of the first embodiment with a primary difference being that the supporting base 100 comprises a bottom seat 110, and also sidewalls 120 and a cover 130.

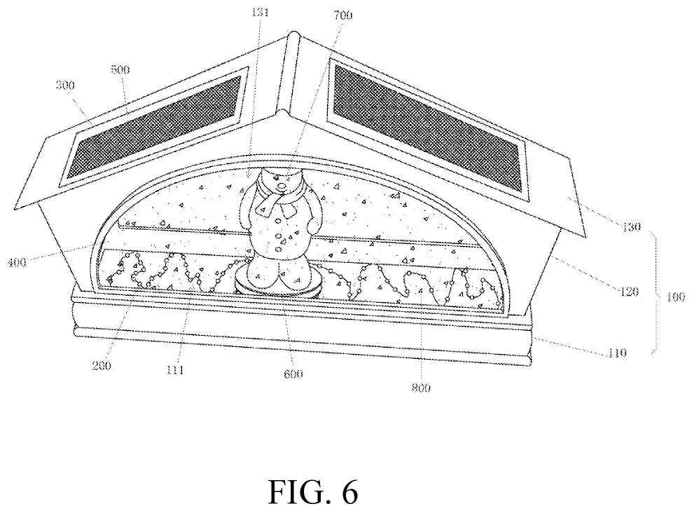

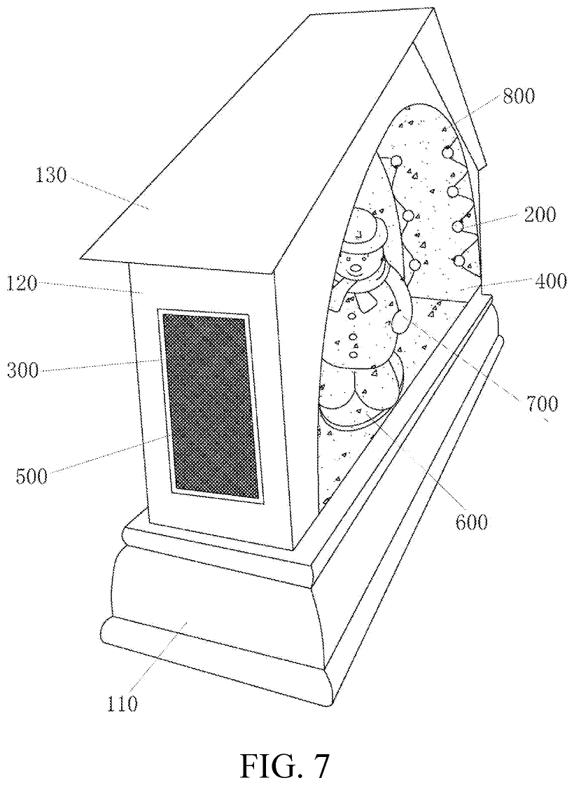

Referring to FIGS. 6 and 7, in the instant embodiment, the supporting base 110 comprises the bottom seat 110, the sidewalls 120, and the top cover 130. The first opening 111 is formed in the bottom seat 110, and the top cover 130 is opened with a second opening 131 facing downward. The bottom seat 110, the sidewalls 120, and the top cover 130 are arranged to house and enclose the water-lamp main body 400. The light-emitting component 200 and the light-transmitting vision window 300 can be provided, solely, on the bottom seat 110, or the sidewalls 120, or the top cover 130, or be provided, in an alternative arrangement, on the bottom seat 110 and the sidewalls 120, or on the bottom seat 110 and the top cover 130, or on the sidewalls 120 and the top cover 130, or, in a further alternative arrangement, be simultaneously provided on all of the bottom seat 110, the sidewalls 120, and the top cover 130. Similarly, the pattern decoration layer 500, and also the patterned light-transmitting laser film thereof, is necessary for being fit in the light-transmitting vision window 300 of the supporting base 100.

In the instant embodiment, for the case that a light-emitting component 200 is arranged on the top cover 130, such a light-emitting component 200 is electrically connected through a circuit assembly inside the bottom seat 110 or a circuit assembly inside the top cover 130 with the light-emitting component 200. When light emits from the light-emitting component 200 of the top cover 130, the light passes through the second opening 131 to irradiate the water-lamp main body 400, and the water-lamp main body 400 projects the light out through the light-transmitting vision window 300 on the sidewalls 120, or the light projecting from the water-lamp main body 400 passes through the first opening 111 to project into the bottom seat 110, and then projecting out through the light-transmitting vision window 300 of the bottom seat 110, to similarly diversify the visual effect of the artifact and to better the playfulness thereof.

Similarly, when the light-emitting component 200 is arranged in the bottom seat 110, the light passes through the first opening 111 to project into the water-lamp main body 400, and is further projected from the water-lamp main body 400 through the second opening 131 into the top cover 130, and when the light-emitting component 200 is arranged on the sidewalls 120, the light passes through the first opening 111 and the second opening 131 to project toward the bottom seat 110 and the top cover 130.

### Embodiment 4

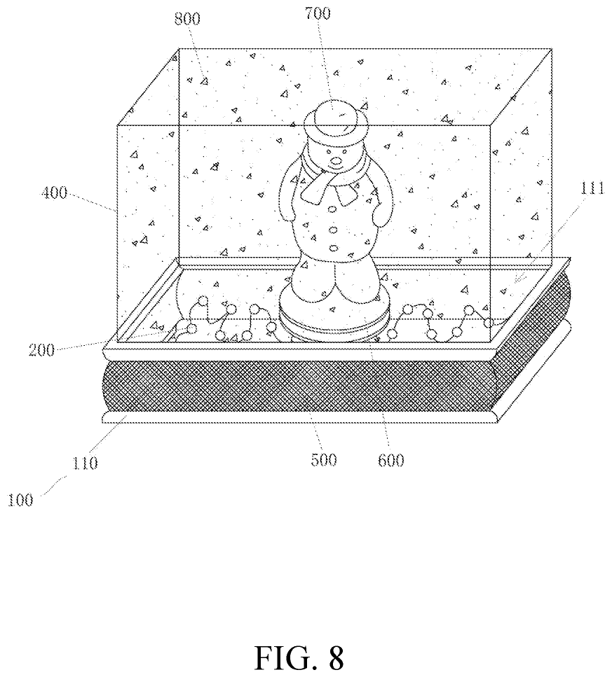

Referring to FIG. 8, in the instant embodiment, an artifact is generally similar to those of the previously-described embodiments, with a difference being that the supporting base 100 is made of a light-transmitting material.

For the case that the supporting base 100 comprises a light-transmitting material, it can be a polycarbonate material, because polycarbonate materials are commonly available in the market and are easy to process and low in cost, and exhibiting a certain degree of light transmission. Thus, when a polycarbonate material is used to make the supporting base 100, light emitting from the light-emitting component 200 can be directly projected to the outside, and thus, in the instant embodiment, the supporting base 100 may also include the light-transmitting vision window 300 described above, and a patterned light-transmitting laser film can be directly fit to an inside surface of the supporting base 100, such that light from the light-emitting component 200 can directly transmit through the light-transmitting laser film for projection of the light, and then, the light can be projected to the outside through the transparent supporting base 100 to similarly present colorful dazzling lighting, thereby enhancing the playfulness and overall visual effect of the artifact.

I claim:

1. A colorful dazzling artifact, comprising:
a supporting base, the supporting base being formed with a first opening and having an interior in which at least one light-emitting component and more than one light-transmitting vision window are arranged;
a water-lamp main body, the water-lamp main body being arranged in the first opening of the supporting base, the water-lamp main body being of a hollow light-transmitting three-dimensional shape, in which a thick flowable liquid is received and hermetically enclosed; and
at least one pattern decoration layer, the pattern decoration layer being fit inside the supporting base and corresponding to the light-transmitting vision window.

2. The colorful dazzling artifact according to claim 1, wherein the pattern decoration layer comprises a light-transmitting laser film that includes a custom-made pattern.

3. The colorful dazzling artifact according to claim 2, wherein the supporting base comprises a bottom seat.

4. The colorful dazzling artifact according to claim 2, wherein the supporting base comprises a bottom seat and further comprises sidewalls, the first opening being arranged in the bottom seat.

5. The colorful dazzling artifact according to claim 2, wherein the supporting base comprises a bottom seat and further comprises sidewalls and a top cover, the first opening being arranged in the bottom seat, the top cover being provided with a second opening and arranged to cover a top of the water-lamp main body.

6. The colorful dazzling artifact according to claim 3, wherein the supporting base is made of a light-transmitting material.

7. The colorful dazzling artifact according to claim 6, wherein the colorful dazzling artifact further comprises a rotating mechanism, the rotating mechanism comprising a driving rotation assembly and a driven rotation assembly, the driving rotation assembly being arranged in the supporting base, the driven rotation assembly being arranged at a bottom inside the water-lamp main body and being drivable by the driving rotation assembly to rotate.

8. The colorful dazzling artifact according to claim 7, wherein the water-lamp main body further comprises an ornamentation object and glitter powder arranged therein, the ornamentation object being mounted to the driven rotation assembly and being drivable to rotate by the driven rotation assembly, the glitter powder being disposed in the flowable liquid.

9. The colorful dazzling artifact according to claim 4, wherein the supporting base is made of a light-transmitting material.

10. The colorful dazzling artifact according to claim 9, wherein the colorful dazzling artifact further comprises a rotating mechanism, the rotating mechanism comprising a driving rotation assembly and a driven rotation assembly, the driving rotation assembly being arranged in the supporting base, the driven rotation assembly being arranged at a bottom inside the water-lamp main body and being drivable by the driving rotation assembly to rotate.

11. The colorful dazzling artifact according to claim 10, wherein the water-lamp main body further comprises an ornamentation object and glitter powder arranged therein, the ornamentation object being mounted to the driven rotation assembly and being drivable to rotate by the driven rotation assembly, the glitter powder being disposed in the flowable liquid.

12. The colorful dazzling artifact according to claim 5, wherein the supporting base is made of a light-transmitting material.

13. The colorful dazzling artifact according to claim 12, wherein the colorful dazzling artifact further comprises a rotating mechanism, the rotating mechanism comprising a driving rotation assembly and a driven rotation assembly, the driving rotation assembly being arranged in the supporting base, the driven rotation assembly being arranged at a bottom inside the water-lamp main body and being drivable by the driving rotation assembly to rotate.

14. The colorful dazzling artifact according to claim 13, wherein the water-lamp main body further comprises an ornamentation object and glitter powder arranged therein, the ornamentation object being mounted to the driven rotation assembly and being drivable to rotate by the driven rotation assembly, the glitter powder being disposed in the flowable liquid.
